(19) United States
(12) Patent Application Publication
(10) Pub. No.: US 2024/0119523 A1
(43) Pub. Date: Apr. 11, 2024

(54) BIFURCATED CONTROL OF DECOUPLED ASYMMETRIC EXCHANGE OVER COMPUTER NETWORK

(71) Applicant: Forge Global, Inc., San Francisco, CA (US)

(72) Inventors: HsiangLi Wu, Burlingame, CA (US); Patrick M. Sellers, Chicago, IL (US); Michael T. Lippold, Newberg, OR (US); Kevyn E. Herrera, Walnut Creek, CA (US); John T. Huang, Cupertino, CA (US)

(21) Appl. No.: 18/148,826

(22) Filed: Dec. 30, 2022

Related U.S. Application Data
(60) Provisional application No. 63/378,476, filed on Oct. 5, 2022.

(51) Int. Cl. G06Q 40/04

(52) U.S. Cl. CPC G06Q 40/04

(57) ABSTRACT

A system includes a server that converts proxies of assets into virtual assets and hosts a session to exchange the virtual assets independent of users to which the proxies belong. The server can perform a decoupled asymmetric exchange based on the virtual assets over one or more network links between a user device and the server and between the user device and an issuer of the proxies. An agent server is delegated by the server to authorize the decoupled asymmetric exchange and route communications over the separate network links based on one or more conditions being satisfied. The system can then allocate the assets to the user device, independent of the users to which the proxies belong.

### CROSS-REFERENCE TO RELATED APPLICATIONS

This application claims the benefit of U.S. Provisional Application No. 63/378,476, filed Oct. 5, 2022, titled “BIFURCATED CONTROL OF DECOUPLED ASYMMETRIC EXCHANGE OVER COMPUTER NETWORK,” which is incorporated herein by reference in its entirety.

### BACKGROUND

An electronic trading platform is a piece of computer software that allows users to place orders for financial products over a network with an intermediary. Examples of the products include stocks, bonds, currencies, commodities, and derivatives. The platforms are available on mobile devices but can provide a website counterpart or Application Programming Interfaces (APIs). Execution over longer-range networks has caused discrepancies in transaction speeds. The speed of data over the Internet, incurring many network switches, also brings on additional time delays. The execution of a transaction physically closer to an electronic exchange or intermediary executes faster than one further away. Further, the availability of such platforms to the public has encouraged a surge in broad investing, requiring scalability to handle network congestion.

Thus, a platform can administer services or transmit products electronically over computer networks. A characteristic of a platform includes scalability, which refers to the ability of a network to handle increasing workloads in an effective and sustainable way, by expanding the network's bandwidth capacity and supporting expansion of additional users or products. A platform that can efficiently scale avoids network congestion, which refers to the reduced quality of service that occurs when a network node or link is carrying more data than it can handle. Typical effects of network congestion include queueing delay, data loss, or the blocking of new connections. A consequence of congestion is that an incremental increase in the network load leads either only to a small increase or even a decrease in network throughput. Therefore, communications of an electronic exchange with or between entities is complex and can impact and be impacted by performance of a network.

### BRIEF DESCRIPTION OF THE DRAWINGS

Detailed descriptions of implementations of the present technology will be described and explained through the use of the accompanying drawings.

FIG. 1A illustrates an exercise and hold process.

FIG. 1B illustrates an exercise and sell process.

FIG. 1C illustrates a sell to cover process.

FIG. 2 illustrates a system including servers configured to perform bifurcated control of a decoupled asymmetric exchange between devices.

FIG. 3 is a flowchart that illustrates processes including bifurcated control of a decoupled asymmetric exchange between devices.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

A computer-implemented platform includes an electronic exchange for users to perform a decoupled asymmetric exchange that exercises options virtually at given values less than current values without initially exchanging the given values during the exchange. As such, the user can liquidate the current value of an option and obtain proceeds without directly exercising the option at the given value. In one example, the platform accepts requests for purchasing equities associated with options and temporarily holds payments from buyers in exchange for equities conditioned on options owned by holders of the options. The holders are invited to participate in a time-restricted session event to liquidate options without needing to exchange given values for current values. Instead, the payments of the purchasers are allocated to exercise the options on behalf of the holders, which bypasses the need for holders to exercise the options in exchange for money (e.g., cash). The platform is scalable for numerous participants in time-restricted events while minimizing network activity required to exercise options.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

The term “option,” as used herein, can refer to a financial instrument that is based on the value of underlying securities such as stocks. An options contract offers a buyer the opportunity to buy or sell the underlying asset. An options contract can have a specific expiration date by which the holder must exercise their option. The stated price on an option is known as the strike price. Options can be bought and sold through an online trading platform. In the context of an electronic trading platform, an option is represented as an electronic element and can be referred to as an element corresponding to a proxy for an asset.

The term “decoupled,” as used herein in the context of an exchange, can refer to having the exchange divided into two or more forks or branches. An exchange refers to a process for trading one thing for another. The decoupled exchange includes two separate asynchronous processes to trade money for assets through intermediary entities that control the exchange in a “bifurcated” manner, to control the exchange with a purchaser device through the electronic platform and an agent. The exchange is “asymmetric” because the two or more processes of the exchange are not necessarily uniform, synchronized, or directly related to each other.

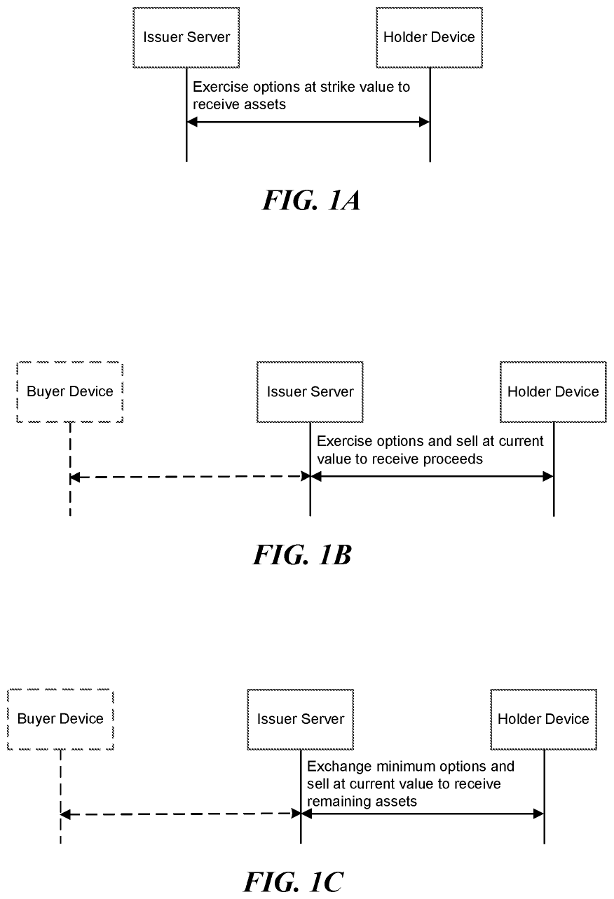

Examples of processes for exercising an option include (i) “exercise and hold,” (ii) “exercise and sell,” and (iii) “sell to cover” processes. FIG. 1A illustrates the exercise and hold process (also referred to as a “cash exercise”). As shown, a holder's user device can communicate with the issuer server to exercise options held by the holder of the options. The user can purchase the underlying assets at the strike value and, in exchange, receive the full number of underlying assets. As such, the user can benefit from any potential future increase of the value of the underlying assets. For example, if the price of an option has a strike value, the holder can purchase the option at the strike value while the underlying asset has a current value different than the strike value. If the current value is greater than the strike value, the delta value (difference) includes proceeds that are allocated to the holder.

FIG. 1B illustrates the exercise and sell process. As shown, the holder's user device can communicate with the issuer server to exercise options and sell the underlying assets at the current value, thereby generating a delta value based on the difference between the strike value and the current value. The assets that are sold exceed the amount required to cover the total cost to exercise all options. The proceeds can thus be sent to the holder user device once all option exercise costs have been paid, including commissions, fees, and taxes. The proceeds from the sale can thus cover the purchase price and additional fees.

FIG. 1C illustrates the sell to cover process. As shown, the holder user device can communicate with the issuer server to exercise options and sell a minimally sufficient number of assets to cover the exercise cost including commissions, fees, and taxes. The holder can then receive the remaining assets in exchange.

The disclosed technology improves over previous processes by enabling a decoupled asymmetric exchange between a purchaser and a holder. As such, holders of proxies to underlying assets can receive proceeds from the sale of the assets without needing to pay to exercise the proxies. Instead, an intermediary service delegates communications that control processes where other parties can pay to exercise the options and buy the underlying assets independent of the holder. The holder can thus receive the proceeds of the sale by posting proxies as virtual assets on an electronic exchange but without ever directly paying to exercise the options. As described later, the service can convert the proxies into virtual assets that are tradable on the electronic exchange. That is, the vested proxies are converted into equivalent assets that are posted for sale during the time-restricted liquidity event. Thus, the vested proxies are treated as assets during the liquidity event for sell intent submission. The holders submit vested proxies as part of sell intent during the event opening period. The platform imposes any restrictions on the assets as well as vested proxies (e.g., maximum 25% vested asset units).

To initiate the process, the service can cause an issuer server to send invitation messages to user device associated with current holders of vested proxies. The invitation messages are communicated serially or in a batch over one or more communications networks to user devices of eligible holders until a predetermined threshold number of holders have accepted the invitation or a threshold number of proxy elements are accepted to post on the electronic exchange. The thresholds can be set to prevent over-loading the electronic exchange with participants.

The invitations can include links that, when clicked, transport the user devices of the holders to a landing page to log into the network portal. The service can administer a network portal for holders to post their vested proxies for sale to other users of the electronic exchange. A particular holder reviews their personal holdings including vested assets and vested proxies from a holder dashboard administered by the intermediary service. In one example, an invitation message includes a link to a form online that requires a signature from an eligible holder to participate in the event. The form can include terms of agreements that are required for participating in the event. In another example, the invitation message can include a control which, when actuated, sends an email including an attached copy of the form for the holder to complete and return to the intermediary. In yet another example, the invitation message includes a link or control that, when clicked or actuated, confirms acceptable of the terms of the agreements in a “single-click” process.

Those holders that are also authorized and eligible to exercise their vested proxies are invited to participate in an event that defines a time-restricted session. The invitation messages can include conditions for participating in the event. Examples of the conditions include being authenticated owners of the proxy elements, which must be vested. The conditions can also include restrictions or constraints on the holders or the proxy assets that can be posted on the electronic exchange. For example, some holders can be precluded from exercising their proxy assets or limit the amount to a fraction of their total holdings and particular periods or points in time.

As such, a holder can exercise and sell proxy assets such that the service or third party pays for the exercise cost from the proceeds of the sale, where the sale is subject to all terms as conditions as set in preexisting agreements. After the event has expired, the delta values are processed and issued as proceeds. Since the exercise of the vested proxies takes place post event expiration, there is no risk of over-exercise. The intermediary service can also generate a holder report to calculate the gross proceeds and cost basis beforehand to inform the holder before agreeing to post the assets.

The issuer receives exercise cost and assists the holders to exercise vested proxies from an existing cap table platform. The issuer can calculate tax withholdings for holder-users who exercise vested proxies during the event. The issuer of the underlying asset can process the holder report and provide deductions (e.g., tax withholdings), if applicable and authorize by the intermediary service for the distribution. The issuer submits the criteria and restrictions to the service, who can generate instructions that delegate communications to an agent server, which is caused to distribute the delta value serially in multiple streams to different parties. In particular, the service can have a preexisting agreement with the agent service to act as an escrow. A first stream of the distribution is for the issuer, to satisfy the exercise cost. A second stream is for the issuer, to satisfy tax withholdings. A third stream is for the service to pay transaction fee, commission fee, and any other service fee. The fourth stream is of the remaining proceeds to the holder. The control is thus bifurcated to handle communications and commands between buyer, agent, issuer, and sellers, and the service delegates communications and commands for the agent to handle allocating proceeds.

### System Overview

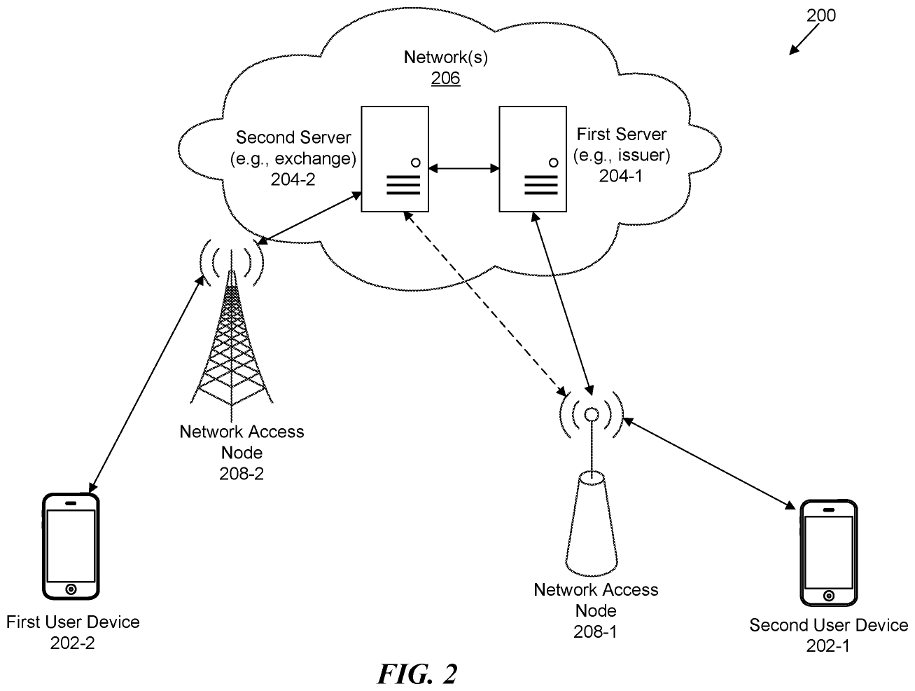

FIG. 2 illustrates a system including servers configured to perform bifurcated control of decoupled asymmetric exchange between devices. The system 200 includes a first user device 202-1 that is communicatively coupled to a first server computer 204-1 over one or more networks 206 via network access node 208-1. A second user device 202-2 is communicatively coupled to a second server computer 204-2 over the one or more networks 206 via the network access node 208-2.

The first user device 202-1 and the second user device 202-2 (referred to collectively as “user devices 202”) can be any type of computing device that can communicate over a wired or wireless communications network with a network node and/or with another computing device over communications network (e.g., computer network, telecommunications network). Examples of the user devices 202 include smartphones, tablet computers, wearable devices, Internet-of-Things (IoT) devices, and laptop or desktop computers, servers, or any other computing device that can access the network(s) 206.

The user devices 202 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The network access node 208-1 and the network access node 208-2 (collectively referred to as “network access nodes 208”) can include any type of network node that can communicate with a user device (e.g., user devices 202) and/or with another network node. The network access nodes 208 can include a network device or apparatus. Examples of network access nodes include a base station (e.g., network access node 208-2), an access point (e.g., network access node 208-1), or any other type of network node such as a network controller, radio network controller (RNC), base station controller (BSC), a relay, transmission points, or any other device that can communicate signals over a wired or wireless communications channel. The system 200 depicts different types of network access nodes 208 to illustrate that the user devices 202 can access different types of networks through different types of network access nodes. For example, a base station (e.g., the network access node 208-2) can provide access to a cellular telecommunications system of the network(s) 206. An access point (e.g., the network access node 208-1) includes a transceiver that provides access to a computer system of the network(s) 206.

The network(s) 206 can include any combination of private, public, wired, or wireless systems such as a cellular network, a computer network, the Internet, and the like. Any data communicated over the network(s) 206 can be encrypted or unencrypted at various locations or along different portions of the network(s) 206. Examples of wireless systems include Wideband Code Division Multiple Access (WCDMA), High Speed Packet Access (HSPA), Wi-Fi, Wireless Local Area Network (WLAN), and Global System for Mobile Communications (GSM), GSM Enhanced Data Rates for Global Evolution (EDGE) Radio Access Network (GERAN), 4G, 5G, 6G wireless wide area networks (WWAN), and other systems that can also benefit from exploiting the scope of this disclosure.

The first server computer 204-1 can include an issuer of proxy elements for underlying assets (e.g., options for underlying equity assets) of private or public entities. In computing technology, a proxy can include a digital representation or intermediary between a requesting resource and the resource itself. As used here, an example of a proxy element includes an option, which is a contract that conveys to its owner, the holder, the right, but not the obligation, to buy or sell an underlying asset or instrument at a specified strike price on or before a specified date, depending on the type of option. Options are typically acquired by purchase, as a form of compensation, or as part of a complex financial transaction. Thus, they are also a form of asset and have a valuation that can depend on a complex relationship between underlying asset value, time until expiration, market volatility, and other factors. Options may be traded between private parties in over-the-counter (OTC) transactions, or they may be exchange-traded in live, orderly markets in the form of standardized contracts.

In one example, a private company can issue options to an employee as part of employment. An example includes an equity option, where the employee can purchase equity in the company after the option has vested. That is, the employee can exchange monetary value for the equity amount indicated in the option. The direct exchange, between the issuer and holder of the option, of money for equity does not require an intervening party. However, the exchange requires that the holder of the option exchange monetary value to exercise the proxy element. Alternatively, an issuer can temporarily hold a number of vested options on behalf of a holder and allow a third party to purchase the underlying assets at a market price, higher than the strike price, such that the proceeds can be returned to the holder or used to purchase the remaining assets that are returned to the holder. In any of these scenarios, the holder of the equity options engages in a direct exchange with the issuer (see, e.g., FIGS. 1A, 1B, 1C). The exchange requires that each party provide something in exchange for something else.

The second server can host a service, application, or platform to exchange proxy elements or assets with participants of a time-restricted session. For example, the second server can host an electronic trading platform (e.g., an electronic exchange) where users can exchange monetary value for assets or proxies of assets. An electronic exchange includes computer software that allows users to place orders for financial products over a network with an intermediary. The products include stocks, bonds, currencies, commodities, derivatives, or digital assets (e.g., cryptocurrencies). The electronic exchange or equivalent are accessible through mobile devices and can provide a website counterpart or Application Programming Interface (API).

As shown and described below, the first server computer can issue proxy elements for the first user device 202-1. The first server computer 204-1 can also communicate with the second server computer 204-2 to post assets on the electronic exchange hosted by the second server computer 204-2. The second user device 202-2 and/or the first user device 202-1 can execute trades on the electronic exchange hosted on the second server computer 204-2.

### Bifurcated Control of Decoupled Asymmetric Exchange

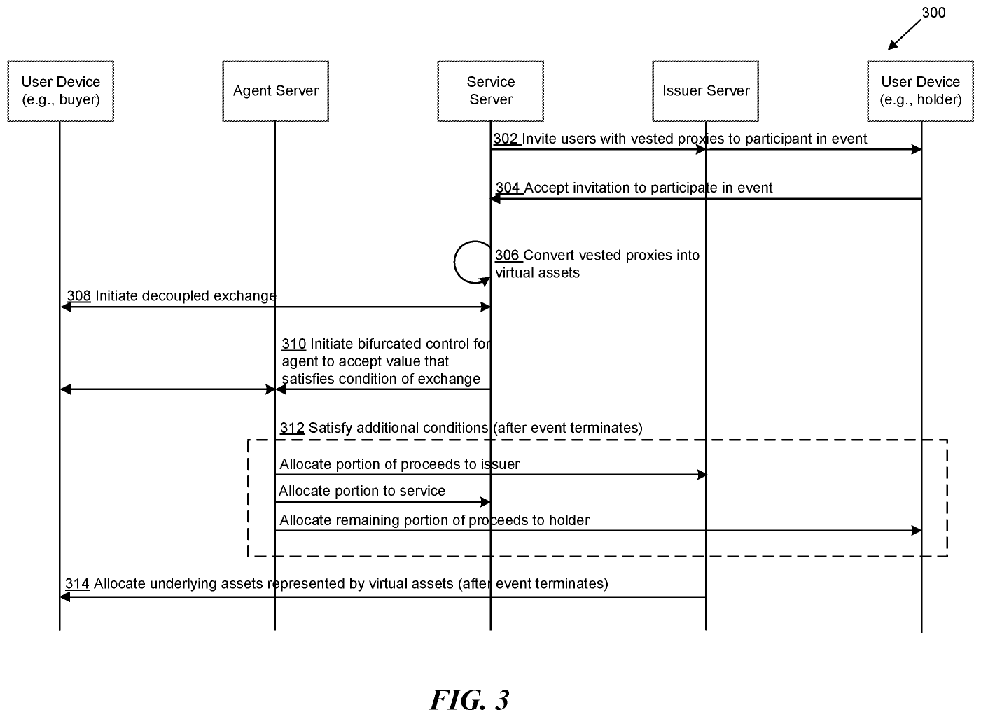

FIG. 3 is a flowchart that illustrates processes including bifurcating control for a decoupled asymmetric exchange between devices. The processes 300 can be performed by a platform or service operating on a system including one or more server computers. The server computers include one or more hardware processors and one or more non-transitory memories storing instructions that, when executed by the hardware processors, cause the system to perform the processes 300. Examples of the servers include the server that issues the proxy elements (“elements”) and a server that hosts an electronic exchange. User devices are operated by the holder of the elements or the buyer of virtual assets on the electronic exchange.

At 302, the system can cause a first server computer to send a query message over a computer network to a first user device for a user (e.g., holder) to join an event including a temporary session hosted by a second server computer, such as an event hosted on an electronic exchange. In one example, the first server computer issues private equity options and the second device operates the electronic exchange to trade virtual assets that represent the vested private equity options to third parties. The system can select multiple users including the first user as having vested elements available for divesting and cause the first server computer to send queries to user devices of the users to join the event hosted at the second server computer. For example, the service can obtain information about holders of private equity options that have vested and, as such, can be exercised by the holder.

The service can cause the issuer to email or otherwise communicate with user devices to invite holders to participate in the time-restricted session hosted by the second server computer. The time-restricted session can correspond to a period where participants can trade virtual assets on the exchange, where the virtual assets represent vested proxy elements. The virtual assets are tradable like regular assets on the electronic exchange environment. The first server computer authenticates the first user as having elements that are vested proxies to assets. The query that is sent to the user device can include a link to route the first user device to the electronic exchange administered by the second server computer and enables the user to post their elements on the electronic exchange.

At 304, the system can receive a request at the second server computer from the user device to join the temporary session and post elements on the electronic exchange. In one example, the holder's elements include unvested proxy assets and vested proxy assets, and the holder is authorized to post only the vested proxy assets on the electronic exchange (e.g., not the unvested proxy assets). In one example, the system can generate an electronic report including an expected equity value of each asset and send the electronic report to the user device, to inform the holder beforehand about an estimated value of the underlying assets and the opportunity to trade the options on the electronic exchange.

In one example, the electronic exchange administered by the second server computer enables trading of private equities. The electronic exchange can include a user interface configured to present profiles of users having elements, and is configured to receive input from users to purchase virtual assets. The assets of the elements posted on the electronic exchange are available to allocate to users after the temporary session has expired, without divesting the elements until one or more conditions are satisfied. The conditions can include monetary value that are provided to purchase the virtual assets, and streaming components of the monetary value to the user device of the holder, the first server computer, and the second server computer.

At 306, the system converts the elements (e.g., vested proxy assets) into virtual assets that are exchangeable for monetary values with authorized users of the electronic exchange. In one example, the system determines a set of elements that are proxies to assets associated with a holder, identifies a subset of elements that vested and unrestricted for exchange during the temporary session, and converts only the subset of elements into the virtual assets. The virtual assets are posted and available for purchase by third parties that are authorized and authenticated to participate in the temporary session. In one example, the vested proxies of assets are converted to the virtual assets that represent equity assets. Thus, the virtual assets can be temporary representations of elements and are configured for exchange for an equity value on the second server computer independent of the holder's user device. In one example, the virtual assets of corresponding elements are exchangeable on the electronic exchange for a particular value per asset. Hence, the virtual assets are allocatable in exchange for a current value per asset different than the original value. The value is thus a requirement or condition that must be satisfied to trade the virtual assets.

At 308, the system delegates the second server computer to perform a decoupled asymmetric exchange based on the virtual assets over separate communications channels/links. One channel/link is between the second user device (e.g., purchaser/buyer) and the second server computer (e.g., host of the electronic exchange) and the other channel/link is between the second user device and the first server computer (e.g., issue of the proxy assets). An agent server is bifurcated by the second server computer to control the decoupled asymmetric exchange, accept values for the virtual assets, and route communications over the separate channels/links to satisfy conditions required to allocate the underlying assets to the second user device.

At 310, the system delegates the agent server to receive input from the second device satisfying a first condition to transfer the virtual assets from the holder to the purchaser. An example of the first condition includes a monetary value corresponding to the current/estimate value of the underlying assets being represented by the virtual assets. After the event closes (e.g., the temporary session ends), the agent server can operate to satisfy additional conditions that are required before the underlying assets can be allocated to the purchaser. In one example, the first condition includes filling an equity value corresponding to a difference between a current equity value of each asset and a strike equity value of each asset. That is, the strike equity value is an initial value assigned to each asset upon assignment to the trader and the current equity value is an estimate equity value of the asset at or about a time when the decoupled exchange is performed.

At 312, the system can cause the agent server to satisfy subsequent conditions for the first server computer and the first user device. In particular, after expiration of the event, proceeds of the decoupled asymmetric event are used to pay the issuer (satisfy a condition), pay any taxes and fees (satisfy another condition), and pay fees taken by the electronic exchange (satisfy another condition). The remaining proceeds are given to the holder of the proxy assets at the user device of the holder (satisfy another condition). For example, after expiration of the event, the agent server serially streams portions of the monetary value paid by the purchaser to the first server computer, the second server, and the first user device. The portions can be streamed serially in that particular order or another order.

At 314, after expiration of the event and after satisfying the required conditions, the system can cause the first server computer to allocate the assets of the elements converted to the virtual assets from the first server computer to the second user device. Hence, the exchange occurs independent of the first user device of the holder and the second server computer hosting the electronic exchange. Thus, the assets are allocated only after the first, second, third, and any other conditions are satisfied, and only after the event ended (e.g., temporary session expired). In one example, the assets are transferred from the first user to the second user anonymously through the second server computer.

Thus, during a liquidity event, in one example, shareholders are invited to an event by their employer (e.g., issuer, private share issuer). The issuer is the driver of the event and will decide when and who is a participant in an event. The issuer can plan the liquidity event around other corporate actions including primary fund raisings, merger and acquisitions, and large corporate restrictions. This can leave shareholders or event participants in a passive situation where they do not have full control of when to sell shares. Further, participants can be invited to the event, but they might not have enough time to get a loan to exercise their shares to participate to the event and eventually lose the opportunity to participate in the event.

An implementation of the disclosed technology includes the aforementioned cashless exercise technique, which can reduce or eliminate utilization of a combination of networked technologies and processes. The technology can facilitate the liquidity event transaction for the shareholders to submit vested options as part of the sell intent and exercise the option at the event expiration by using the buyer submitted fund from the escrow account to facilitate the option's exercise.

As such, the technology alleviates the need for shareholders to acquire a loan to exercise their vested options prior to participating in the issuer-led liquidity event. Since there is no loan process, a lead time is not required for participating in the event. Further, put participants (usually smaller shareholders) are in equal ground as other larger shareholders who might have millions in assets and are able to pull assets from other investments to exercise vested options. In addition, exercise options can take from 14 days to 30 business days. Shareholders can miss the trading window if they have new vested options; however, with the cashless exercise technology, shareholders who have vested options can participate in the event without going through the prolonged option exercise process in advance. This can reduce the risk that shareholders miss the trading window.

The disclosed technology can also implement one or more computer models to improve the efficiency and effectiveness of the processes disclosed herein. A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, participants or objects (e.g., options) for an event can be selected based on a model such as a neural network with multiple input nodes that receive inputs from the system. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used to select participants or options for the event. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes prior participants or events, or types of options as inputs and a desired output, such as participants or options for a particular event. A representation of an event (including participants and options) can be provided to the model. Output from the model can be compared to the desired output for that event and, based on the comparison, the model can be modified, such as by changing weights between nodes of the neural network or parameters of the functions used at each node in the neural network (e.g., applying a loss function). After applying each of the inputs in the training data and modifying the model in this manner, the model can be trained to evaluate new participants, options, events, or combinations thereof.

### Computer System

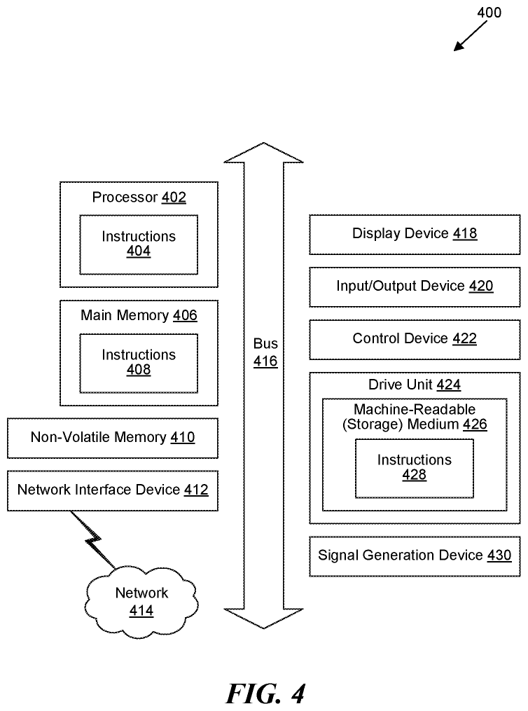

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, video display device 418, an input/output device 420, a control device 422 (e.g., keyboard and pointing device), a drive unit 424 that includes a storage medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementation, the computer system 400 can be an embedded computer system, a system-on-chip (SOC), a single-board computer system (SBC) or a distributed system such as a mesh of computer systems or include one or more cloud components in one or more networks. Where appropriate, one or more computer systems 400 can perform operations in real-time, near real-time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### REMARKS

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A system comprising:
at least one hardware processor; and
at least one non-transitory memory storing instructions, which, when executed by the at least one hardware processor, cause the system to:
cause a first server computer to send a query over a computer network to a first user device for a first user to join a session in a virtual environment hosted by a second server computer,
wherein the first server computer is configured to determine that the first user has elements that are proxies to assets, and
wherein the query includes a link configured to route the first user device to an electronic exchange administered by a second server computer and enable the first user to post indications of the elements on the electronic exchange;
receive, based on the link, a request at the second server computer from the first device to join the session and post the indications of the elements on the electronic exchange;
in response to the request, cause the first device to join the session and post the indications of the elements on the electronic exchange;
convert the proxy elements into virtual assets that are configured for transfer between authorized users on the electronic exchange;
initiate performing a decoupled asymmetric exchange of the virtual assets over separate communication channels including (i) a first channel between a second user device of a second user and the second server computer and (ii) a second channel between the second user device and the first server computer;
cause the second server computer to delegate an agent server
configured to route communications over the first communications channels in response to one or more preset conditions being satisfied,
wherein indications of the one or more preset conditions are stored in a memory of the system;
after the session has expired, cause the agent server to, based on an input received from the second user device, transfer control of the virtual assets from the first user to the second user; and
cause the first server computer to allocate, over the second communication channel, the assets of the elements converted to the virtual assets from the first server computer to the second user device, independent of the first user device and the second server computer.

2. The system of claim 1 further caused to, prior to the assets being allocated to the second user device and after the session has expired:
cause the agent server to receive input from the second device satisfying a first condition to transfer the virtual assets from the first user to the second user; and
cause the agent server to satisfy a second condition of the first server computer and a third condition of the first user device based on the first condition,
wherein allocating the assets is conditioned on the first, second, and third conditions being satisfied.

3. The system of claim 2 further caused to:
assign each asset to the first user; and
in response to assignment to the first user, assign a first equity value as an initial value to each asset,
wherein the first condition includes filling an equity value corresponding to a difference between a second equity value of each asset and the first equity value of each asset, and
wherein the second equity value is an estimate future equity value of the asset at a time when the decoupled asymmetric exchange is performed.

4. The system of claim 1 further caused to:
cause the first user to post only vested proxy assets on the electronic exchange, wherein the elements include unvested proxy assets and vested proxy assets.

5. The system of claim 1, wherein the assets are transferred from the first user to the second user anonymously through the second server computer.

6. The system of claim 1 further caused to:
configure the assets of the elements posted on the electronic exchange to assign to users during the session without divesting the elements until the one or more preset conditions are satisfied and after the session has expired.

7. The system of claim 1 further caused to:
enable exchange of the elements for the assets in exchange for a first equity value per asset; and
allocate the virtual assets in exchange for a second equity value per asset different than the first equity value,
wherein the one or more preset conditions are satisfied based on a delta equity value corresponding to a difference between the second equity value and the first equity value.

8. The system of claim 1:
wherein the electronic exchange administered by the second server computer corresponds to an electronic exchange of private equities, and
wherein the electronic exchange includes a user interface configured to present profiles of users having proxy elements to assets and is configured to receive input from users to allocate virtual assets.

9. The system of claim 1:
wherein the first server computer is an issuer of options for private securities, and
wherein the second server computer administers the electronic exchange of vested options of the private securities as virtual securities.

10. The system of claim 1 further caused to, prior to the request being received at the second server computer from the first device to join the session:
generate an electronic report including an expected equity value of each asset; and
send the electronic report to the first user device.

11. The system of claim 1 further caused to, prior to the elements being converted into virtual assets:
determine a set of elements that are proxies to assets associated with the first user;
identify a subset of the set of elements that are vested and unrestricted for exchange during the session; and
convert only the subset of the set of elements into the virtual assets.

12. The system of claim 1, wherein the virtual assets are temporary representations of the assets of the elements and are configured for exchange for an equity value on the second server computer independent of the first device.

13. The system of claim 1 further caused to, prior to the query being sent to the first user device for the first user to join the session hosted at the second server computer:
select multiple users including the first user as having elements as proxies to assets available for exercising; and
cause the first server computer to send queries to user devices of the multiple users to join the session hosted at the second server computer.

14. The system of claim 1:
wherein the first server computer is configured to issue options corresponding to the elements as proxies of securities for private companies, and
wherein the second device is operable as an electronic exchange to offer the securities to third parties.

15. The system of claim 1 further caused to, prior to the assets being allocated to the second user:
post the virtual assets available for third parties that are authorized and authenticated to participate in the session.

16. A computer-readable storage medium, excluding transitory signals and carrying instructions, which, when executed by at least one data processor of a system, cause the system to:
create a temporary session hosted on a server computer to enable exchanging virtual assets representing vested proxies of assets,
wherein the vested proxies of assets are converted to the virtual assets having equity values that correspond to current equity values of the assets;
perform a decoupled asymmetric exchange based on the virtual assets over separate network links including a first link between a user device and the server computer and a second link between the user device and an issuer server of the vested proxies of assets,
wherein an agent is delegated by the server computer to route messages over the separate network links based on one or more conditions being satisfied; and
cause the issuer server to allocate the assets converted to the virtual assets from the issuer server to the user device, independent of the server computer.

17. The computer-readable storage medium of claim 16 further caused to, prior to the assets being allocated to the user device:
cause the agent to receive input from the user device satisfying a first condition to transfer the virtual assets to a user of the user device; and
cause the agent to satisfy additional conditions based on the first condition,
wherein allocating the assets is conditioned on the first condition and the additional conditions being satisfied.

18. The computer-readable storage medium of claim 16, wherein the server computer administers a user interface configured to present profiles of users having vested proxies of assets and is configured to receive input from users to allocate virtual assets.

19. A computer-implemented platform operating on one or more server computers comprising:
at least one hardware processor; and
at least one non-transitory memory storing instructions, which, when executed by the at least one hardware processor, cause the one or more server computers to:
cause a first server computer to send a query to a first user device for a first user to join an event hosted by a second server computer,
wherein the first user is associated with proxies to assets and include vested proxies that redeemable for the assets,
wherein the query is to post the vested proxies on a network portal administered by the second server computer, and
wherein the assets of the vested proxies posted on the network portal are available for transfer to users of the event without redeeming the vested proxies;
receive an indication at the second server computer that the first device accepted the query to join the event and post the vested proxies on the network portal;
in response to the acceptance, convert the vested proxies into virtual assets that are transferrable via the network portal;
initiate transfer of the virtual assets from the second server computer to a second user device,
wherein the transfer of the virtual assets is performed through an agent server operable as an agent of the second server computer,
cause the agent server to receive input from the second device including submitting a value that satisfies a requirement to transfer the virtual assets of the second server computer;
after expiration of the event:
cause the agent server to serially stream portions of the value to the first server computer, the second server computer, and the first user device; and
allocate the assets associated with the virtual assets to a second user of the second user device.

20. The computer-implemented platform of claim 19, wherein the assets of the vested proxies are posted on an electronic exchange as virtual assets and are available to purchase by users during the event without exercising the vested proxies until serially streamed portions of the value are complete and after the event expires.
